(19) United States
(12) Patent Application Publication
(10) Pub. No.: US 2026/0214570 A1
(43) Pub. Date: Jul. 23, 2026

(54) UE BEHAVIOR IN ENERGY SAVING NETWORK

(71) Applicant: LENOVO (BEIJING) LIMITED, Beijing (CN)

(72) Inventors: Ran Yue, Beijing (CN); Haiming Wang, Beijing (CN); Lianhai Wu, Beijing (CN); Min Xu, Beijing (CN)

(21) Appl. No.: 19/134,308

(22) PCT Filed: Jan. 20, 2023
(86) PCT No.: PCT/CN2023/073400

§ 371 Date: May 30, 2025

(51) Int. Cl. H04W 52/02

(52) U.S. Cl. CPC H04W 52/0216

(57) ABSTRACT

Methods and apparatuses for energy saving network are disclosed. In one embodiment, a UE comprises a processor; and a transceiver coupled to the processor, wherein, the UE supports network energy saving (NES), and the processor is configured to receive, via the transceiver, a cell discontinuous reception (DRX) configuration, the cell DRX configuration comprises information associated with at least one duration for a first cell to not receive at least partial UL transmission from the UE.

### FIELD

The subject matter disclosed herein generally relates to wireless communications, and more particularly relates to methods and apparatuses for UE behavior in an energy saving network.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), master information block (MIB), synchronization signal block (SSB), system information block (SIB), network energy saving (NES), discontinuous transmission (DTX), discontinuous reception (DRX), configure grant (CG), Sounding Reference Signal (SRS), random access channel (RACH), Physical Uplink Control Channel (PUCCH), medium access control (MAC), control element (CE), Protocol Data Unit (PDU), hybrid automatic repeat request (HARQ), transport block size (TBS), Physical Uplink Shared Channel (PUSCH), uplink control indicator (UCI), downlink control indicator (DCI), bandwidth part (BWP), information element (IE).

This disclosure relates to UE behavior in an energy saving network.

### BRIEF SUMMARY

Methods and apparatuses for energy saving network are disclosed.

In one embodiment, a UE comprises a processor; and a transceiver coupled to the processor, wherein, the UE supports network energy saving (NES), and the processor is configured to receive, via the transceiver, a cell discontinuous reception (DRX) configuration, the cell DRX configuration comprises information associated with at least one duration for a first cell to not receive at least partial UL transmission from the UE.

In some embodiment, a UE comprises a processor; and a transceiver coupled to the processor, wherein, the UE supports network energy saving (NES), and the processor is configured to receive, via the transceiver, a cell discontinuous reception (DRX) configuration including cell DRX ON duration and cell DRX OFF duration, and determine UL resource for UL transmission, if allocated UL resource for UL transmission overlaps with the cell DRX OFF duration.

In some embodiment, the determined UL resource for UL transmission is available UL resource included in the allocated UL resource for UL transmission, wherein the available UL resource does not overlap with the cell DRX OFF duration. The processor may be further configured to assemble or reassemble MAC PDU(s) according to the available UL resource. The determined UL resource for UL transmission is the next allocated UL resource for UL transmission that does not overlap with the cell DRX OFF duration, and the processor is further configured to receive, via the transceiver, a configuration of enabling autonomous transmission or autonomous retransmission for UL transmission, and transmit, via the transceiver, the UL transmission by autonomous transmission or autonomous retransmission.

In some embodiment, the processor is further configured to transmit, via the transceiver, the UL transmission on the allocated UL resource for UL transmission that overlaps with the cell DRX OFF duration. The processor may be further configured to receive, via the transceiver, a configuration of enabling autonomous retransmission of the UL transmission, and a timer associated with the autonomous retransmission; start the timer upon transmitting the UL transmission; and upon the timer being expired, retransmit, via the transceiver, the UL transmission on the next allocated UL resource for UL transmission that does not overlap with the cell DRX OFF duration.

In some embodiment, the processor is further configured to receive, via the transceiver, a configuration on forbidding piggyback on PUCCH transmitted in UL resource that overlaps with the cell DRX OFF duration.

In some embodiment, if the allocated UL resource for UL transmission that overlaps with the cell DRX OFF duration is by dynamic scheduling, the dynamic scheduling is ignored.

In another embodiment, a method performed by a UE that supports network energy saving (NES) comprises receiving a cell discontinuous reception (DRX) configuration, the cell DRX configuration comprises information associated with at least one duration for a first cell to not receive at least partial UL transmission from the UE.

In still another embodiment, a network device comprises a processor; and a transceiver coupled to the processor, wherein, the network device supports network energy saving (NES), and the processor is configured to transmit, via the transceiver, a cell DRX configuration, the cell DRX configuration comprises information associated with at least one duration for a first cell to not receive at least partial UL transmission from UE.

In some embodiment, a network device that supports network energy saving (NES) comprises a processor; and a transceiver coupled to the processor, wherein, the processor is configured to transmit, via the transceiver, a cell DRX configuration including cell DRX ON duration and cell DRX OFF duration; and transmit, via the transceiver, a first control message that indicates or implies a dynamic configuration, and the dynamic configuration temporarily overrides the cell DRX configuration.

In some embodiment, the first control message or a second control message that follows the first control message schedules a UL transmission by allocating a UL resource for the UL transmission, and if the allocated UL resource for UL transmission overlaps with the cell DRX OFF duration, at least a part of the next cell DRX OFF duration is determined as cell DRX ON, wherein, the part of the next cell DRX OFF duration determined as cell DRX ON includes the allocated UL resource for UL transmission.

In some embodiment, if the first control message is transmitted in cell DRX ON duration, a first cell DRX OFF duration following the cell DRX ON duration is the next cell DRX OFF duration, and the part of the next cell DRX OFF duration determined as cell DRX ON starts from the start of the first cell DRX OFF duration or the start of receiving the UL transmission, and ends at the end of receiving the UL transmission or at the end of the first cell DRX OFF duration; and if the first control message is transmitted in a second cell DRX OFF duration, the second cell DRX OFF duration is the next cell DRX OFF duration, and the part of the next cell DRX OFF duration determined as cell DRX ON starts upon transmitting the first control message or from the start of receiving the UL transmission, and ends at the end of receiving the UL transmission or at the end of the second cell DRX OFF duration.

In some embodiment, the dynamic configuration overrides one or more next cell DRX ON durations or one or more next cell DRX OFF durations.

In yet another embodiment, a method performed by a network device that supports network energy saving (NES) comprises transmitting a cell DRX configuration, the cell DRX configuration comprises information associated with at least one duration for a first cell to not receive at least partial UL transmission from UE.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates cell DRX configuration;

FIG. 2 illustrates some situations between the CG resources and the cell DRX OFF durations;

FIG. 3 illustrates a specific example of the overlapped resource;

FIG. 4 illustrates a first example and a second example of the first sub-embodiment of the second embodiment;

FIG. 5 illustrates a third example of the first sub-embodiment of the second embodiment;

FIG. 6 illustrates an example that both the cell DRX configuration and the cell DTX configuration are configured;

FIG. 7 is a schematic flow chart diagram illustrating an embodiment of a method;

FIG. 8 is a schematic flow chart diagram illustrating a further embodiment of a method; and

FIG. 9 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE, 3GPP NR-U, NR Radio Access operating with shared spectrum channel access and so on. It is contemplated that along with the developments of network architectures and new service scenarios, all embodiments in the present application are also applicable to similar technical problems. Moreover, the terminologies recited in the present application may change, which should not affect the principle of the present application. Embodiments of the present disclosure can also be applied to unlicensed spectrum scenario.

To make description clearer, a few concepts are clarified.

NES UE can be also referred to a NES capable UE, or a UE that supports NES technologies, or a UE with the capability to support NES technologies.

A network energy saving (NES) cell is a cell that supports NES technologies.

For the NES cell, periodic cell discontinuous transmission (DTX) mode and cell discontinuous reception (DRX) mode can be configured by UE-specific RRC signally and operated separately. Alternatively, cell DTX and cell DRX can also be configured and operated together.

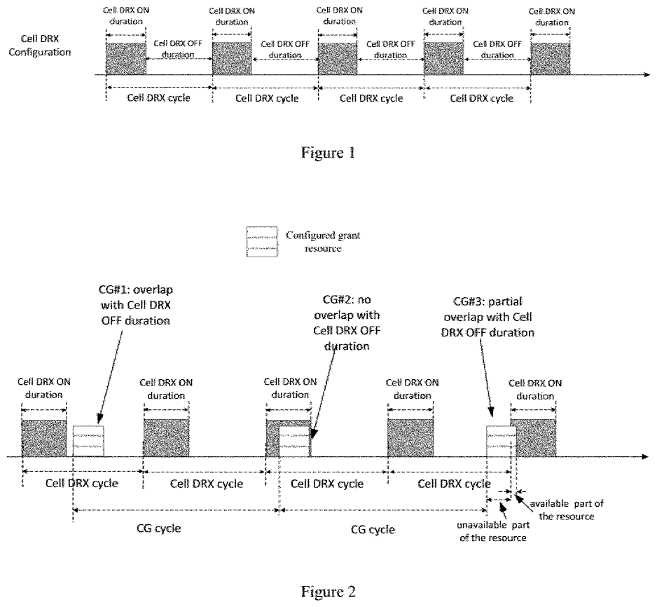

A cell DRX configuration configures cell DRX of a NES cell (e.g., a serving cell), e.g., a cell DRX cycle. The cell DRX configuration comprises information associated with at least one duration for a first cell to not receive at least partial UL transmission from the UE. For example, as shown in FIG. 1, the cell DRX cycle includes cell DRX ON duration, in which the NES cell is active for reception (e.g., can receive signal from UEs), and cell DRX OFF duration, in which the NES cell is inactive for reception (e.g., can NOT receive signal from UEs). Incidentally, in cell DRX OFF duration, it is possible that the NES cell can NOT receive all of UL transmissions from UEs (i.e., can receive parts of UL transmissions) or can only receive specific UL transmissions (e.g. SRS or PRACH or preconfigured UL transmission or preconfigured RBs) from UEs. In this disclosure, it is assumed that, in cell DRX OFF duration, the NES cell can NOT receive any signal from UEs or the NES cell can NOT receive the UL transmission described in this disclosure. The length (e.g., in unit of ms, or in unit of slot(s) and symbol(s)) of the cell DRX cycle, as well as the length of the cell DRX ON duration or the length of the cell DRX OFF duration can be also configured in the cell DRX configuration. In the above example, the cell DRX cycle includes cell DRX ON duration and cell DRX OFF duration. Alternatively, it is possible that only cell DRX ON duration or only cell DRX OFF duration is configured. It means that, if only the cell DRX ON duration is configured, the other duration other than the cell DRX ON duration can be regarded as cell DRX OFF duration without explicit configuration. Similarly, if only the cell DRX OFF duration is configured, the other duration other than the cell DRX OFF duration can be regarded as cell DRX ON duration without explicit configuration. Moreover, the expression “cell DRX ON duration” and/or the expression “cell DRX OFF duration”, if configured, may be named as other expression(s) with the same explanation as described above.

Similarly, a cell DTX configuration configures cell DTX of a NES cell (e.g., a serving cell), e.g., a cell DTX cycle including cell DTX ON duration, in which the NES cell is active for transmission (e.g., can transmit signal to UEs), and cell DTX OFF duration, in which the NES cell is inactive for transmission (e.g., can NOT transmit any signal to UEs). Incidentally, in cell DTX OFF duration, it is possible that the NES cell can only transmit parts of data or signaling, or only transmit specific data or signaling (e.g. SSB or reference signal or DCI or preconfigured DL transmission or preconfigured RBs). In this disclosure, it is assumed that, in cell DTX OFF duration, the NES cell can NOT transmit any signal to UEs or the NES cell can NOT transmit the DL transmission except that is described in this disclosure or the DL transmission except described in this disclosure does not affect the embodiments in this disclosure. The length (e.g., in unit of ms, or in unit of slot(s) and symbol(s)) of the cell DTX cycle, as well as the length of the cell DTX ON duration or the length of the cell DTX OFF duration can be also configured in the cell DTX configuration. It is possible that only cell DTX ON duration or only cell DTX OFF duration is configured. It means that, if only the cell DTX ON duration is configured, the other duration other than the cell DTX ON duration can be regarded as cell DTX OFF duration without explicit configuration. Similarly, if only the cell DTX OFF duration is configured, the other duration other than the cell DTX OFF duration can be regarded as cell DTX ON duration without explicit configuration. Moreover, the expression “cell DTX ON duration” and/or the expression “cell DTX OFF duration”, if configured, may be named as other expression(s) with the same explanation as described above.

As described above, if cell DRX for a serving cell is configured, e.g., the UE receives the cell DRX configuration from the network (e.g., from gNB that manages the serving cell), the UE is expected not to transmit UL transmission during the cell DRX OFF duration which will not be received by the serving cell from UEs in the cell DRX OFF duration.

A first embodiment relates to UE behavior if a UL resource for UL transmission is allocated to overlap with the cell DRX OFF duration.

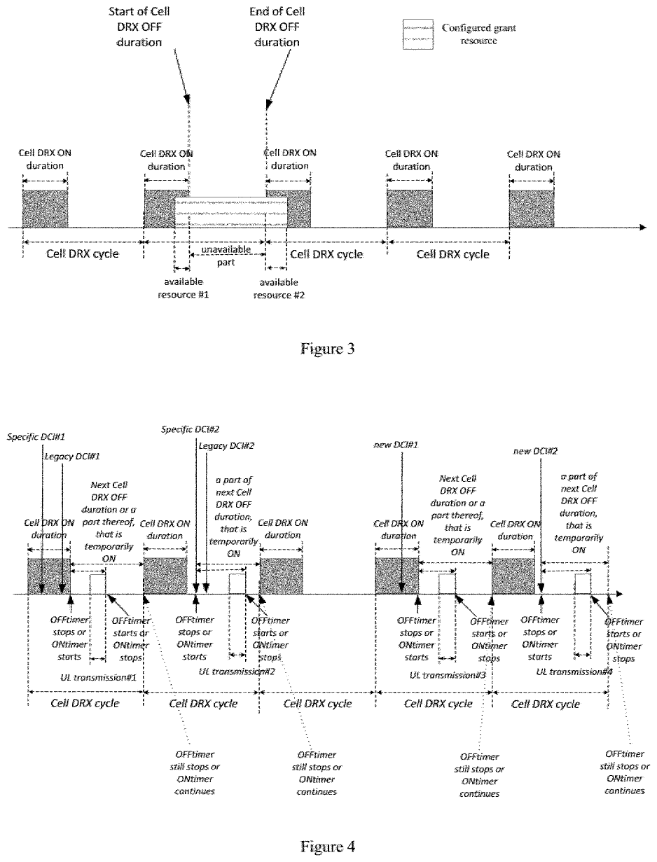

Periodic UL transmission resources (e.g., configure grant (CG) resources) can be configured to the UE which accesses to a NES cell. When UE receives CG, multiple or multiple continuous or periodic UL transmission resources (e.g., CG resources) are allocated to the UE. CG resources are periodical. It means that there is a CG cycle between two consecutive CG resources (see FIG. 3).

There is a possibility that some of the allocated CG resources overlap with the cell DRX OFF duration.

It means that the UL transmission is to be transmitted on a duration that the cell is unable for reception. FIG. 2 illustrates some situations between the CG resources and the cell DRX OFF durations. For simplicity, FIG. 2 does not label the cell DRX OFF duration. The cell DRX OFF duration is the length in each cell DRX cycle except for the cell DRX ON duration. In other words, there is a cell DRX OFF duration following each cell DRX ON duration. CG resource #1 (CG #1) overlaps (fully overlaps) with a cell DRX OFF duration. CG resource #2 (CG #2) does not overlap with the cell DRX OFF duration. CG resource #3 (CG #3) partially overlaps with the cell DRX OFF duration.

If the UE transmits UL transmission on the CG resource that overlaps with the cell DRX OFF duration, the serving cell, which is inactive to receive the UL transmission during the cell DRX OFF duration, can NOT successfully receive the UL transmission. For example, if the UE transmits UL transmission on CG resource #1, or on the overlapped part of the CG resource #3 (labeled as “unavailable part of the resource” in FIG. 2), the UL transmission can NOT be received by the serving cell. Incidentally, if the UL transmission is transmitted in a CG resource that overlaps partially with the cell DRX OFF duration, there is a small possibility that the UL transmission can be successfully received by the serving cell. In this disclosure, it is assumed that the UL transmission in a UL resource (e.g., CG resource) that overlaps partially with the cell DRX OFF duration can NOT be successfully received by the serving cell if there is no indication that the UL transmission is successfully received from the network.

In addition to the CG resources, the UL transmissions on other UL resources (e.g., SRS, RACH, PUCCH, etc), either allocated periodically or dynamically scheduled, may also overlap with the cell DRX OFF duration.

As a whole, if the cell DRX configuration (especially, the cell DRX OFF duration) is configured and there is no indication or configuration that the UL transmission is able to be received, there is a problem that the UE may transmit UL transmission during the cell DRX OFF duration, which leads to that the transmitted UL transmission can NOT be correctly received by the serving cell.

According to a first sub-embodiment of the first embodiment, the UE does not consider the allocated UL resource or the part of the allocated UL resource that overlaps with the cell DRX OFF duration as valid. If the entire length of the allocated UL resource overlaps with the cell DRX OFF duration (see CG #1 in FIG. 2), the whole of the allocated UL resource is not considered. If the allocated UL resource overlaps partially with the cell DRX OFF duration (see CG #3 in FIG. 2), the allocated UL resource can be divided into an available part of the allocated UL resource (that does not overlap with the cell DRX OFF duration) and an unavailable part of the allocated UL resource (that overlaps with the cell DRX OFF duration). The available part can be also referred to valid part. The part of the allocated UL resource that overlaps with the cell DRX OFF duration is referred to as the unavailable part of the allocated UL resource. The unavailable part can be also referred to as invalid part. That is, the UE does not consider the unavailable part of the allocated UL resource as valid if the allocated UL resource overlaps partially with the cell DRX OFF duration.

In particular, when the UE assembles MAC PDU(s) according to the allocated UL resources, if the UE knows that the whole of the allocated UL resource overlaps with the cell DRX OFF duration, the whole of the UL resource is not considered as valid. The UE does not transmit the UL transmission.

If a part of the allocated UL resource overlaps with the cell DRX OFF duration, the UE assembles the MAC PDU(s) according to the available part (i.e., valid part) of the allocated UL resource (i.e., the part of the allocated UL resources that does not overlap with the cell DRX OFF duration), and transmits the UL transmission on the available part of the allocated UL resource.

If the UE knows that the whole of the allocated UL resource overlaps with the cell DRX OFF duration after the UE assembles the MAC PDU(s), the UE does not transmit the UL transmission. In particular, the UE discards the assembled MAC PDU(s) or maintains the assembled MAC PDU(s).

If the UE knows that a part of the allocated UL resource overlaps with the cell DRX OFF duration after the UE assembles the MAC PDU(s), the UE reassembles MAC PDU(s) according to the available part of the allocated UL resource (i.e., the part of the allocated UL resources that does not overlap with the cell DRX OFF duration), and transmits the UL transmission on the available part of the allocated UL resource.

The feature “the UE does not consider the allocated UL resource or the part of the allocated UL resource that overlaps with the cell DRX OFF duration as valid” can be implemented as a configurable feature configured by the network (e.g., by the gNB). The gNB may allow the feature by sending a configuration.

FIG. 3 illustrates a specific example of the overlapped resource. As shown in FIG. 3, the CG resource overlaps with the cell DRX OFF duration. The CG resource starts prior to the start of the cell DRX OFF duration and ends after the end of the cell DRX OFF duration. If the part of CG resource that overlaps with the cell DRX OFF duration (i.e., the unavailable part) is not considered, the available part of the CG resource includes two parts: available resource #1 (that is in front of the start of the cell DRX OFF duration) and available resource #2 (that is after the end of the cell DRX OFF duration). The UE may determine any of the available resource #1 and the available resource #2 as the UL resource for UL transmission. Alternatively, both the available resource #1 and the available resource #2 can be determined as the UL resource for UL transmission.

If both the available resource #1 and the available resource #2 are determined as the UL resource for UL transmission, one HARQ process can be associated with both the available resource #1 and the available resource #2 (i.e., the available resource #1 and the available resource #2 are considered as one UL resource for UL transmission), or each of the available resource #1 and the available resource #2 is associated with a different HARQ process (i.e., the available resource #1 and the available resource #2 are considered as two separate UL resources for UL transmission).

According to a second sub-embodiment of the first embodiment, the UE does not perform UL transmission in any UL resource that overlaps with the cell DRX OFF duration. It means that if a UL resource overlaps (e.g., fully overlaps (see CG #1 in FIG. 2) or partially overlaps (see CG #3 in FIG. 2)), the UE does not transmit UL transmission on the overlapped UL resource.

In addition, autonomous transmission and/or autonomous retransmission of the UL transmission are allowed (e.g., via configuration by the network). It means that the UE shall transmit the UL transmission that is not transmitted due to overlapped UL resource on a next available or valid resource (e.g., a next available or valid resource that has the same TBS as the overlapped UL resource). For example, with reference to FIG. 2, the UL transmission that is not transmitted in CG #1 due to CG #1 overlapping with the cell DRX OFF duration can be transmitted in the next available resource CG #2 that does not overlap with the cell DRX OFF duration. Preferably, CG #2 has the same TBS as CG #1.

If the UL transmission in the next available resource is regarded as a new transmission (since the UL transmission is transmitted the first time), it is referred to as autonomous transmission.

If the UL transmission that should be transmitted in the overlapped UL resource is regarded as a new transmission (although not transmitted), the UL transmission in the next available resource may be regarded as a retransmission, which is referred to as autonomous retransmission.

The UL transmission that shall be transmitted in the overlapped UL resource is associated with a HARQ process. Since the UL transmission is not transmitted in the overlapped UL resource, the state of the HARQ process associated with the UL transmission can be set to or considered as “suspended” or “pending” or “not transmitted”. If the retransmission timer (e.g., cg-RetransmissionTimer) related to the HARQ process is running, the retransmission timer is stopped.

After the autonomous transmission or autonomous retransmission of the UL transmission in the next available resource (to ensure that the UL transmission is successfully received at the serving cell), the state of the HARQ process associated with the UL transmission can be set to or considered as “not suspended” or “not pending” or “transmitted”. In addition, if the CG timer (e.g., configuredGrantTimer) and the retransmission timer (e.g., cg-RetransmissionTimer) related to the HARQ process are running, the CG timer (for example, the CG timer is stopped if successfully reception is indicated to the UE) and/or the retransmission timer are stopped.

According to a third sub-embodiment of the first embodiment, the UE transmits UL transmission on the allocated UL resource. It means that even if the allocated UL resource overlaps (e.g., fully overlaps (see CG #1 in FIG. 2) or partially overlaps (see CG #3 in FIG. 2)) with the cell DRX OFF duration, the UE transmits the UL transmission on the overlapped UL resource.

A new timer (or an existing timer, e.g., cg-RetransmissionTimer being reused) is configured to the HARQ process associated with the UL transmission to control the transmission and/or retransmission of the UL transmission.

The new timer starts when the UL transmission is transmitted (e.g., on the overlapped UL resource).

Due to the cell DRX OFF duration, the UL transmission on the overlapped UL resource can NOT be successfully received by the serving cell. The state of the HARQ process associated with the UL data can be set to or considered as “suspended” or “pending” or “not received”.

The UL transmission that is not successfully received by the serving cell can be later transmitted upon receiving a dynamic scheduling of the UL transmission.

Alternatively, autonomous transmission or autonomous retransmission of the UL transmission is allowed (e.g., via configuration by the network). It means that the UL transmission that is not successfully received by the serving cell will be transmitted (if it is regarded as the new transmission) or retransmitted (if it is regarded as the retransmission) on the next available resource (e.g., the next available resource that has the same TBS as the overlapped UL resource) by the UE autonomously.

Once the new timer expires and no acknowledgement or unacknowledgement is received from the network (which means that the UL transmission fails), the autonomous transmission or autonomous retransmission of the UL transmission can be transmitted if the state of the HARQ process associated with the UL data is “suspended” or “pending” or “not received”.

After the UL transmission associated with the HARQ process is successfully transmitted (e.g., successfully received by the serving cell), the state of the HARQ process associated with the UL data can be set to or considered as “not suspended” or “not pending” or “received”. The new timer is stopped.

A fourth sub-embodiment of the first embodiment relates to UCI piggybacking on PUSCH.

A UCI is transmitted on a PUCCH. If there is a PUSCH to be transmitted, the UCI can be transmitted by being piggybacked on the PUSCH, instead of being transmitted on the PUCCH.

If the PUSCH resource on which the PUSCH is transmitted overlaps with the cell DRX OFF duration (which would cause the PUSCH including the UCI piggybacked on the PUSCH can NOT be successfully received by the serving cell), while the PUCCH that transmits the UCI does not overlap with the cell DRX OFF duration, the UCI can be transmitted on the PUCCH instead of being piggybacked on the PUSCH.

The feature of “transmitting the UCI on the PUCCH instead of being piggybacked on the PUSCH to be transmitted on overlapped PUSCH resource” can be allowed by a configuration from the network (e.g., gNB).

A second embodiment relates to dynamic configuration of the cell DRX configuration (e.g., dynamic configuration of cell DRX OFF duration and/or cell DRX ON duration).

A first sub-embodiment of the second embodiment relates to dynamic configuration of the cell DRX OFF duration.

According to the first sub-embodiment, it is allowed or configurable (e.g., by network) to temporarily override the cell DRX OFF duration by a dynamic configuration. That is, a dynamic configuration of the cell DRX OFF duration can be configured.

The dynamic configuration (that temporarily overrides the cell DRX OFF duration) can be configured per cell.

The dynamic configuration can be indicated by a DCI, or a MAC CE, or a RRC signaling.

The dynamic configuration of the cell DRX OFF duration can be “not start the cell DRX OFF duration” (i.e., “start the cell DRX ON duration”) or “cut the cell DRX OFF duration short”. It means that the next cell DRX OFF duration of a part thereof is changed temporarily to cell DRX ON (i.e., active for reception). The dynamic configuration can be for example indicated by a specific DCI that does not schedule a UL transmission (and optionally a legacy DCI that follows the specific DCI schedules a UL transmission) (a first example) or a new DCI that also schedule a UL transmission (a second example). The dynamic configuration may be transmitted to all UEs in a cell, a specific UE, or one or more groups of UEs (e.g., by group ID allocated to UE(s) belonging to a group).

In the first example, a specific DCI indicates the dynamic configuration of the cell DRX OFF duration, and another legacy DCI following the specific DCI schedules a UL transmission in view of the dynamic configuration. The specific DCI indicates “not start the cell DRX OFF duration” (i.e., “start the cell DRX ON duration”) as the dynamic configuration. When the UE receives the specific DCI, the UE considers that the next cell DRX OFF duration is changed temporarily to cell DRX ON (i.e., active for reception).

If the UE receives the specific DCI (e.g., specific DCI #1 in FIG. 4) in a cell DRX ON duration, the cell DRX OFF duration following the cell DRX ON duration is the next cell DRX OFF duration, and the next cell DRX OFF duration becomes cell DRX ON from the start of the next cell DRX OFF duration. If a timer (e.g., OFFtimer) related to cell DRX OFF duration runs, the UE stops the OFFtimer when the next cell DRX OFF duration starts. If a timer (e.g., ONtimer) related to cell DRX OFF duration runs, the UE starts the ONtimer when the next cell DRX OFF duration starts.

A legacy DCI #1 following the specific DCI #1 schedules a UL transmission #1 in the next cell DRX OFF duration that is configured to cell DRX ON by the specific DCI #1. The end of the cell DRX ON for the next cell DRX OFF duration can be the end of the UL transmission #1. In this condition, if the OFFtimer stops when the next cell DRX OFF duration starts, the OFFtimer starts at the end of the UL transmission #1; or if the ONtimer starts when the next cell DRX OFF duration starts, the ONtimer stops at the end of the UL transmission #1. Alternatively, the end of the cell DRX ON for the next cell DRX OFF duration can be the end of the next cell DRX OFF duration. In this condition, if the OFFtimer stops when the next cell DRX OFF duration starts, the OFFtimer still stops since the next cell DRX ON duration starts; or if the ONtimer starts when the next cell DRX OFF duration starts, the ONtimer continues since the next cell DRX ON duration starts.

If the UE receives the specific DCI (e.g., specific DCI #2 in FIG. 4) in a cell DRX OFF duration, the cell DRX OFF duration is referred to as the next cell DRX OFF duration. The next cell DRX OFF duration becomes cell DRX ON upon receiving the specific DCI #2. If a timer (e.g., OFFtimer) related to cell DRX OFF duration runs, the UE stops the OFFtimer upon receiving the specific DCI #2. If a timer (e.g., ONtimer) related to cell DRX OFF duration runs, the UE starts the ONtimer upon receiving the specific DCI #2.

A legacy DCI #2 following the specific DCI #2 schedules a UL transmission #2 in the next cell DRX OFF duration that is configured to cell DRX ON by the specific DCI #2. The end of the cell DRX ON for the next cell DRX OFF duration can be the end of the UL transmission #2 (wherein, if the OFFtimer stops upon receiving the specific DCI #2, the OFFtimer starts at the end of the UL transmission #2; or if the ONtimer starts upon receiving the specific DCI #2, the ONtimer stops at the end of the UL transmission #2) or the end of the next cell DRX OFF duration (wherein, if the OFFtimer stops upon receiving the specific DCI #2, the OFFtimer still stops; or if the ONtimer starts upon receiving the specific DCI #2, the ONtimer continues).

In the second example, a new DCI schedules a UL transmission and at the same time indicates the dynamic configuration of the cell DRX OFF duration. In other words, the new DCI can function as both the specific DCI indicating the dynamic configuration of the cell DRX OFF duration and the legacy DCI scheduling the UL transmission.

As shown in FIG. 4, new DCI #1 received in a cell DRX ON duration schedules a UL transmission #3 (which is to be transmitted in the next cell DRX OFF duration) and at the same time indicates the dynamic configuration of the cell DRX OFF duration. The next cell DRX OFF duration becomes cell DRX ON from the start of the next cell DRX OFF duration. If a timer (e.g., OFFtimer) related to cell DRX OFF duration runs, the UE stops the OFFtimer when the next cell DRX OFF duration starts. If a timer (e.g., ONtimer) related to cell DRX ON duration runs, the UE starts the ONtimer when the next cell DRX OFF duration starts. The end of cell DRX ON for the cell DRX OFF duration, as well as ‘start’ or ‘stop’ of the OFFtimer or the ONtimer are the same as the first example by specific DCI #1.

New DCI #2 received in a cell DRX OFF duration schedules a UL transmission #4 and at the same time indicates the dynamic configuration of the cell DRX OFF duration. The next cell DRX OFF duration becomes cell DRX ON upon receiving the new DCI #2. If a timer (e.g., OFFtimer) related to cell DRX OFF duration runs, the UE stops the OFFtimer upon receiving the new DCI #2. If a timer (e.g., ONtimer) related to cell DRX OFF duration runs, the UE starts the ONtimer upon receiving the new DCI #2. The end of cell DRX ON for the cell DRX OFF duration, as well as ‘start’ or ‘stop’ of the OFFtimer or the ONtimer are the same as the first example by specific DCI #2.

In the above description, the new DCI schedules a UL transmission (which is to be transmitted in the next cell DRX OFF duration) and at the same time indicates the dynamic configuration of the cell DRX OFF duration explicitly. Alternatively, if there is not new DCI transmitted or defined, a legacy DCI can be used to imply the dynamic configuration of the cell DRX OFF duration. The legacy DCI can only schedule a UL transmission (which is to be transmitted in the next cell DRX OFF duration), which implies that the dynamic configuration of the cell DRX OFF duration shall be applied. It means that if a legacy DCI schedules a UL transmission to be transmitted in the next cell DRX OFF duration, the legacy DCI can be regarded as a new DCI implicitly indicating a dynamic configuration of the cell DRX OFF duration.

In the first and the second examples, the specific DCI or the new DCI indicates “not start the cell DRX OFF duration” (i.e., “start the cell DRX ON duration”) as the dynamic configuration. So, the next cell DRX OFF duration becomes cell DRX ON when the next cell DRX OFF duration starts (if the specific DCI or the new DCI is received in a cell DRX ON duration) or upon receiving the specific DCI or the new DCI (if the specific DCI or the new DCI is received in a cell DRX OFF duration). In a third example, the specific DCI or the new DCI indicates “cut the cell DRX OFF duration short”. It means that the next cell DRX OFF duration becomes cell DRX ON when the scheduled UL transmission (by the legacy DCI or the new DCI) starts. In addition, the cell DRX ON for the next cell DRX OFF duration ends when the scheduled UL transmission ends. That is, the next cell DRX OFF duration only becomes cell DRX ON during the time period in which the scheduled UL transmission is transmitted.

FIG. 5, which illustrates the third example, differs from FIG. 4, which illustrates the first example and the second example, in the position of “OFFtimer stops or ONtimer starts”, which is the start of the scheduled UL transmission #1 or #2 or #3 or #4, while there is no “OFFtimer still stops or ONtimer continues”. The position of “OFFtimer starts or ONtimer stops”, which is the end of the scheduled UL transmission #1 or #2 or #3 or #4, remains the same.

In the above examples, the specific DCI or the new DCI indicates “not start the cell DRX OFF duration” (i.e., “start the cell DRX ON duration”) or “cut the cell DRX OFF duration short” as the dynamic configuration, which means that the dynamic configuration is only effective for the next cell DRX OFF duration. In a fourth example, the specific DCI or the new DCI indicates “not start the cell DRX OFF duration for k times” or “start the cell DRX ON duration for k times”, where k is a positive integer, the UE considers the next k cell DRX OFF durations are changed temporarily to cell DRX ON.

According to a second sub-embodiment of the second embodiment, the cell DRX OFF duration does not change. If the UE receives a DCI scheduling UL transmission to be transmitted on UL resource(s) that overlap with the cell DRX OFF duration, the allocation of the UL resource(s) is ignored. It means that the scheduled UL transmission is not transmitted. The state of the HARQ process associated with the scheduled UL transmission can be set to or considered as “suspended” or “pending” or “not transmitted”. Another DCI may schedule the UL transmission to be transmitted on next UL resource(s) that do not overlap with the cell DRX OFF duration. After the UL transmission is successfully transmitted on the next UL resource(s), the state of the HARQ process associated with the scheduled UL transmission can be set to or considered as “not suspended” or “not pending” or “transmitted”.

According to a third sub-embodiment of the second embodiment, it is allowed or configurable (e.g., by network) to override the cell DRX ON duration by dynamic configuration in a similar way to the first sub-embodiment. That is, a dynamic configuration of the cell DRX ON duration can be configured. The dynamic configuration (that temporarily overrides the cell DRX ON duration) can be configured per cell.

The dynamic configuration can be indicated by a DCI, or a MAC CE, or a RRC signaling, or broadcast information with new IE, or paging message with new indication, or short message with new bit. The indication may be transmitted to all UEs in a cell, a specific UE, or one or more groups of UEs (e.g., by group ID allocated to UE(s) belonging to a group).

For example, a specific DCI can indicate the dynamic configuration of the cell DRX ON duration. The specific DCI may indicate “not start the cell DRX ON duration”. When the UE receives the specific DCI, the UE considers that the next cell DRX ON duration is changed temporarily to cell DRX OFF (i.e., inactive for reception). If the UE receives the specific DCI in a cell DRX OFF duration, the cell DRX ON duration following the cell DRX OFF duration is the next cell DRX OFF duration, and the next cell DRX ON duration becomes cell DRX OFF from the start of the next cell DRX OFF duration. If the UE receives the specific DCI in a cell DRX ON duration, the cell DRX ON duration is referred to as the next cell DRX OFF duration. The next cell DRX ON duration becomes cell DRX OFF upon receiving the specific DCI.

The specific DCI may indicate “not start the cell DRX ON duration for k times”, where k is a positive integer, the UE considers the next k cell DRX ON durations are changed temporarily to cell DRX OFF.

A third embodiment relates to the handle of the timers related to the serving cell.

The timer, e.g., sCellDeactivationTimer, is used to control the activated state or deactivated state of the serving cell. A value is configured to the timer sCellDeactivation Timer by the network, e.g., from a set of predetermined values. The timer, e.g., bwp-InactivityTimer, is used to control the activated state or deactivated state of the BWP of the serving cell if BWP is configured. A value is configured to the timer bwp-InactivityTimer by the network, e.g., from a set of predetermined values.

If cell DRX configuration is indicated for the serving cell, the serving cell does not receive UL transmission in the cell DRX OFF duration. So, the cell is equivalent to be deactivated. So, the timer to control the activated state or deactivated state of the serving cell or of the BWP should not calculate the cell DRX OFF duration. It means that, when the timer to control the activated state or deactivated state of the serving cell or of the BWP is configured but the value is not configured in consideration of the cell DRX OFF duration, the UE shall add the time duration of a cell DRX OFF duration to the value of the timer upon each cell DRX OFF duration. Alternatively, the set of predetermined values shall be expanded to include one or multiple larger values that are larger than the predetermined values. For example, the larger values are determined based on the cell DRX OFF durations. Accordingly, the value configured to the timer can be selected from one of larger values included in the expanded set if the cell DRX configuration (e.g., the cell DRX OFF duration) is configured.

To achieve this, a UE comprises a processor; and a transceiver coupled to the processor, wherein, the UE supports network energy saving (NES), and the processor is configured to receive, via the transceiver, a cell discontinuous reception (DRX) configuration including at least cell DRX OFF duration, and if a timer that controls the activated state or deactivated state of the serving cell or of the BWP of the serving cell is configured with a value, the time length of each cell DRX OFF duration is added to the configured value of the timer, or a larger value is configured to the timer. A network device comprises a processor; and a transceiver coupled to the processor, wherein, the network device supports network energy saving (NES), and the processor is configured to transmit, via the transceiver, a cell DRX configuration, and configure a larger value to a timer that controls the activated state or deactivated state of the serving cell or of the BWP of the serving cell.

Similarly, if cell DTX configuration is indicated for the serving cell, the serving cell does not transmit UL transmission in the cell DTX OFF duration. So, the cell is equivalent to be deactivated. So, the timer to control the activated state or deactivated state of the serving cell or of the BWP should not calculate the cell DTX OFF duration. It means that, when the timer to control the activated state or deactivated state of the serving cell or of the BWP is configured but the value is not configured in consideration of the cell DTX OFF duration, the UE shall add the time duration of a cell DTX OFF duration to the value of the timer upon each cell DTX OFF duration. Alternatively, the set of predetermined values shall be expanded to include one or multiple larger values that are larger than the predetermined values. For example, the larger values are determined based on the cell DTX OFF durations. Accordingly, the value configured to the timer can be selected from one of larger values included in the expanded set if the cell DTX configuration (e.g., the cell DTX OFF duration) is configured.

To achieve this, a UE comprises a processor; and a transceiver coupled to the processor, wherein, the UE supports network energy saving (NES), and the processor is configured to receive, via the transceiver, a cell discontinuous transmission (DTX) configuration including at least cell DTX OFF duration, and if a timer that controls the activated state or deactivated state of the serving cell or of the BWP of the serving cell is configured with a value, the time length of each cell DTX OFF duration is added to the configured value of the timer, or a larger value is configured to the timer. A network device comprises a processor; and a transceiver coupled to the processor, wherein, the network device supports network energy saving (NES), and the processor is configured to transmit, via the transceiver, a cell DRX configuration, and configure a larger value to a timer that controls the activated state or deactivated state of the serving cell or of the BWP of the serving cell.

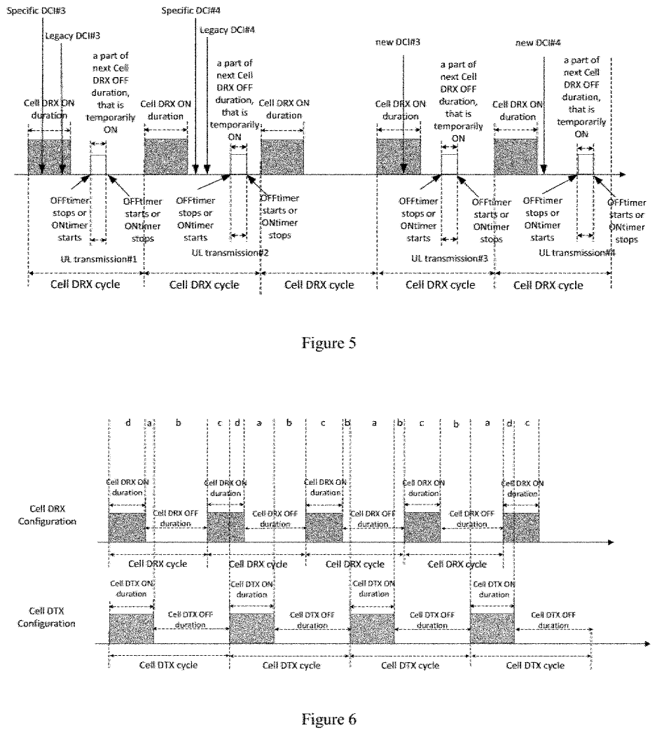

The cell DRX configuration and the cell DTX configuration can be both configured. As shown in FIG. 6, each time period “a” is DRX OFF and DTX ON; each time period “b” is DRX OFF and DTX OFF; each time period “c” is DRX ON and DTX OFF; and each time period “d” is DRX ON and DTX ON. The time periods to be added to the value of the timer are time periods “a”, “b” and “c” or only the time period “b”. Alternatively, the set of predetermined values shall be expanded to include one or multiple larger values that are larger than the predetermined values. For example, the larger values are determined based on the cell DRX OFF durations and/or the cell DTX OFF durations. Accordingly, the value configured to the timer can be selected from one of larger values included in the expanded set if the cell DRX configuration (e.g., the cell DRX OFF duration) and/or the cell DTX configuration (e.g., the cell DTX OFF duration) are configured.

To achieve this, a UE comprises a processor; and a transceiver coupled to the processor, wherein, the UE supports network energy saving (NES), and the processor is configured to receive, via the transceiver, a cell discontinuous reception (DRX) configuration including at least cell DRX OFF duration and a cell discontinuous transmission (DTX) configuration including at least cell DTX OFF duration, and if a timer that controls the activated state or deactivated state of the serving cell or of the BWP of the serving cell is configured with a value, the time length of each cell DRX OFF duration and/or each cell DTX OFF duration is added to the configured value of the timer, or a larger value is configured to the timer. A network device comprises a processor; and a transceiver coupled to the processor, wherein, the network device supports network energy saving (NES), and the processor is configured to transmit, via the transceiver, a cell DRX configuration and a cell DTX configuration, and configure a larger value to a timer that controls the activated state or deactivated state of the serving cell or of the BWP of the serving cell.

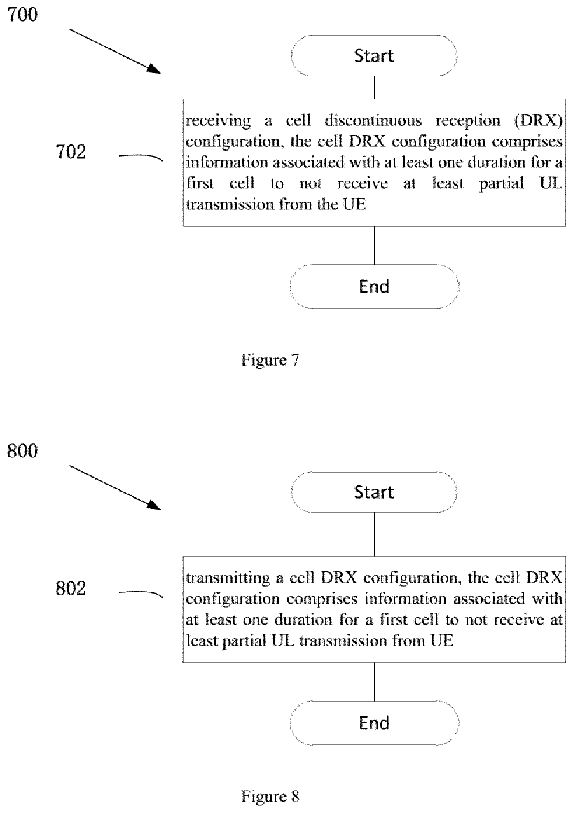

FIG. 7 is a schematic flow chart diagram illustrating an embodiment of a method 700 according to the present application. In some embodiments, the method 700 is performed by an apparatus, such as a remote unit (UE). In certain embodiments, the method 700 may be performed by a processor executing program code, for example, a microcontroller, a microprocessor, a CPU, a GPU, an auxiliary processing unit, a FPGA, or the like.

The method 700 may be performed by a UE that supports network energy saving (NES), the method comprises 702 receiving a cell discontinuous reception (DRX) configuration, the cell DRX configuration comprises information associated with at least one duration for a first cell to not receive at least partial UL transmission from the UE.

In some embodiment, a method performed by a UE that supports network energy saving (NES) comprises receiving a cell DRX configuration including cell DRX ON duration and cell DRX OFF duration; and determining UL resource for UL transmission, if allocated UL resource for UL transmission overlaps with the cell DRX OFF duration.

In some embodiment, the determined UL resource for UL transmission is available UL resource included in the allocated UL resource for UL transmission, wherein the available UL resource does not overlap with the cell DRX OFF duration. The method may further comprise assembling or reassembling MAC PDU(s) according to the available UL resource. In some embodiment, the determined UL resource for UL transmission is the next allocated UL resource for UL transmission that does not overlap with the cell DRX OFF duration, and the method further comprises receiving a configuration of enabling autonomous transmission or autonomous retransmission for UL transmission, and transmitting the UL transmission by autonomous transmission or autonomous retransmission.

In some embodiment, the method further comprises transmitting the UL transmission on the allocated UL resource for UL transmission that overlaps with the cell DRX OFF duration. Further, the method may further comprise receiving a configuration of enabling autonomous retransmission of the UL transmission, and a timer associated with the autonomous retransmission; starting the timer upon transmitting the UL transmission; and upon the timer being expired, retransmitting the UL transmission on the next allocated UL resource for UL transmission that does not overlap with the cell DRX OFF duration.

In some embodiment, the method further comprise receiving a configuration on forbidding piggyback on PUCCH transmitted in UL resource that overlaps with the cell DRX OFF duration.

In some embodiment, if the allocated UL resource for UL transmission that overlaps with the cell DRX OFF duration is by dynamic scheduling, the dynamic scheduling is ignored.

In some embodiment, a method performed by a UE that supports network energy saving (NES) comprises receiving a cell DRX configuration including cell DRX ON duration and cell DRX OFF duration; and receiving a first control message that indicates or implies a dynamic configuration, and the dynamic configuration temporarily overrides the cell DRX configuration.

In some embodiment, the first control message or a second control message that follows the first control message schedules a UL transmission by allocating a UL resource for the UL transmission, and if the allocated UL resource for UL transmission overlaps with the cell DRX OFF duration, at least a part of a next cell DRX OFF duration is determined as cell DRX ON, wherein, the part of the next cell DRX OFF duration determined as cell DRX ON includes the allocated UL resource for UL transmission. If the first control message is received in cell DRX ON duration, a first cell DRX OFF duration following the cell DRX ON duration is a next cell DRX OFF duration, and the part of the next cell DRX OFF duration determined as cell DRX ON starts from the start of the first cell DRX OFF duration or the start of transmitting the UL transmission, and ends at the end of transmitting the UL transmission or at the end of the first cell DRX OFF duration; and if the first control message is received in a second cell DRX OFF duration, the second cell DRX OFF duration is the next cell DRX OFF duration, and the part of the next cell DRX OFF duration determined as cell DRX ON starts upon receiving the first control message or from the start of transmitting the UL transmission, and ends at the end of transmitting the UL transmission or at the end of the second cell DRX OFF duration.

In some embodiment, the dynamic configuration overrides one or more next cell DRX ON durations or one or more next cell DRX OFF durations.

In some embodiment, the cell DRX configuration includes cell DRX ON duration and cell DRX OFF duration, the method further comprises receiving cell DTX configuration including cell DTX ON duration and cell DTX OFF duration, and if a timer that controls the activated state or deactivated state of the serving cell or of the BWP of the serving cell is configured with a value, the time length of each cell DRX OFF duration and/or each cell DTX OFF duration is added to the configured value of the timer, or a larger value is configured to the timer.

FIG. 8 is a schematic flow chart diagram illustrating a further embodiment of a method 800 according to the present application. In some embodiments, the method 800 is performed by an apparatus, such as a base unit or a network device. In certain embodiments, the method 800 may be performed by a processor executing program code, for example, a microcontroller, a microprocessor, a CPU, a GPU, an auxiliary processing unit, a FPGA, or the like.

The method 800 may be performed by a network device, wherein, the network device supports network energy saving (NES), and the method comprises 802 transmitting a cell DRX configuration, the cell DRX configuration comprises information associated with at least one duration for a first cell to not receive at least partial UL transmission from UE.

In some embodiment, a method performed by a network device that supports network energy saving (NES) comprises transmitting a cell DRX configuration including cell DRX ON duration and cell DRX OFF duration, and transmitting a first control message that indicates or implies a dynamic configuration, and the dynamic configuration temporarily overrides the cell DRX configuration.

In some embodiment, the first control message or a second control message that follows the first control message schedules a UL transmission by allocating a UL resource for the UL transmission, and if the allocated UL resource for UL transmission overlaps with the cell DRX OFF duration, at least a part of the next cell DRX OFF duration is determined as cell DRX ON, wherein, the part of the next cell DRX OFF duration determined as cell DRX ON includes the allocated UL resource for UL transmission.

In some embodiment, if the first control message is transmitted in cell DRX ON duration, a first cell DRX OFF duration following the cell DRX ON duration is the next cell DRX OFF duration, and the part of the next cell DRX OFF duration determined as cell DRX ON starts from the start of the first cell DRX OFF duration or the start of receiving the UL transmission, and ends at the end of receiving the UL transmission or at the end of the first cell DRX OFF duration; and if the first control message is transmitted in a second cell DRX OFF duration, the second cell DRX OFF duration is the next cell DRX OFF duration, and the part of the next cell DRX OFF duration determined as cell DRX ON starts upon transmitting the first control message or from the start of receiving the UL transmission, and ends at the end of receiving the UL transmission or at the end of the second cell DRX OFF duration.

In some embodiment, the dynamic configuration overrides one or more next cell DRX ON durations or one or more next cell DRX OFF durations.

In some embodiment, the method further comprises configuring a larger value to a timer that controls the activated state or deactivated state of the serving cell or of the BWP of the serving cell.

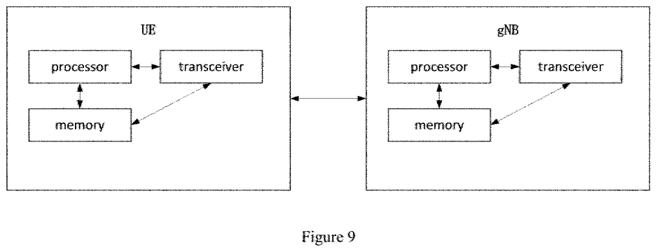

FIG. 9 is a schematic block diagram illustrating apparatuses according to one embodiment.

Referring to FIG. 9, the UE (i.e., remote unit, or terminal device) includes a processor, a memory, and a transceiver. The processor implements a function, a process, and/or a method which are proposed in FIG. 7.

The UE comprises a processor; and a transceiver coupled to the processor, wherein, the UE supports network energy saving (NES), and the processor is configured to receive, via the transceiver, a cell discontinuous reception (DRX) configuration, the cell DRX configuration comprises information associated with at least one duration for a first cell to not receive at least partial UL transmission from UE.

In some embodiment, a UE comprises a processor; and a transceiver coupled to the processor, wherein, the UE supports network energy saving (NES), and the processor is configured to receive, via the transceiver, a cell discontinuous reception (DRX) configuration including cell DRX ON duration and cell DRX OFF duration, and determine UL resource for UL transmission, if allocated UL resource for UL transmission overlaps with the cell DRX OFF duration.

In some embodiment, the determined UL resource for UL transmission is available UL resource included in the allocated UL resource for UL transmission, wherein the available UL resource does not overlap with the cell DRX OFF duration. The processor may be further configured to assemble or reassemble MAC PDU(s) according to the available UL resource. The determined UL resource for UL transmission is the next allocated UL resource for UL transmission that does not overlap with the cell DRX OFF duration, and the processor is further configured to receive, via the transceiver, a configuration of enabling autonomous transmission or autonomous retransmission for UL transmission, and transmit, via the transceiver, the UL transmission by autonomous transmission or autonomous retransmission.

In some embodiment, the processor is further configured to transmit, via the transceiver, the UL transmission on the allocated UL resource for UL transmission that overlaps with the cell DRX OFF duration. The processor may be further configured to receive, via the transceiver, a configuration of enabling autonomous retransmission of the UL transmission, and a timer associated with the autonomous retransmission; start the timer upon transmitting the UL transmission; and upon the timer being expired, retransmit, via the transceiver, the UL transmission on the next allocated UL resource for UL transmission that does not overlap with the cell DRX OFF duration.

In some embodiment, the processor is further configured to receive, via the transceiver, a configuration on forbidding piggyback on PUCCH transmitted in UL resource that overlaps with the cell DRX OFF duration.

In some embodiment, if the allocated UL resource for UL transmission that overlaps with the cell DRX OFF duration is by dynamic scheduling, the dynamic scheduling is ignored.

In some embodiment, a UE comprises a processor; and a transceiver coupled to the processor, wherein, the UE supports network energy saving (NES), and the processor is configured to receive, via the transceiver, a cell discontinuous reception (DRX) configuration including cell DRX ON duration and cell DRX OFF duration, and receive, via the transceiver, a first control message that indicates or implies a dynamic configuration, and the dynamic configuration temporarily overrides the cell DRX configuration.

In some embodiment, the first control message or a second control message that follows the first control message schedules a UL transmission by allocating a UL resource for the UL transmission, and if the allocated UL resource for UL transmission overlaps with the cell DRX OFF duration, at least a part of a next cell DRX OFF duration is determined as cell DRX ON, wherein, the part of the next cell DRX OFF duration determined as cell DRX ON includes the allocated UL resource for UL transmission.

In some embodiment, if the first control message is received in cell DRX ON duration, a first cell DRX OFF duration following the cell DRX ON duration is a next cell DRX OFF duration, and the part of the next cell DRX OFF duration determined as cell DRX ON starts from the start of the first cell DRX OFF duration or the start of transmitting the UL transmission, and ends at the end of transmitting the UL transmission or at the end of the first cell DRX OFF duration; and if the first control message is received in a second cell DRX OFF duration, the second cell DRX OFF duration is the next cell DRX OFF duration, and the part of the next cell DRX OFF duration determined as cell DRX ON starts upon receiving the first control message or from the start of transmitting the UL transmission, and ends at the end of transmitting the UL transmission or at the end of the second cell DRX OFF duration.

In some embodiment, the dynamic configuration overrides one or more next cell DRX ON durations or one or more next cell DRX OFF durations.

In some embodiment, the cell DRX configuration includes cell DRX ON duration and cell DRX OFF duration, the processor is further configured to receive, via the transceiver, cell DTX configuration including cell DTX ON duration and cell DTX OFF duration, and if a timer that controls the activated state or deactivated state of the serving cell or of the BWP of the serving cell is configured with a value, the time length of each cell DRX OFF duration and/or each cell DTX OFF duration is added to the configured value of the timer, or a larger value is configured to the timer.

Referring to FIG. 9, the gNB (i.e., base unit or network device) includes a processor, a memory, and a transceiver. The processor implements a function, a process, and/or a method which are proposed in FIG. 8.

The network device comprises a processor; and a transceiver coupled to the processor, wherein, the network device supports network energy saving (NES), and the processor is configured to transmit, via the transceiver, a cell DRX configuration, the cell DRX configuration comprises information associated with at least one duration for a first cell to not receive at least partial UL transmission from UE.

In some embodiment, a network device that supports network energy saving (NES) comprises a processor; and a transceiver coupled to the processor, wherein, the processor is configured to transmit, via the transceiver, a cell DRX configuration including cell DRX ON duration and cell DRX OFF duration; and transmit, via the transceiver, a first control message that indicates or implies a dynamic configuration, and the dynamic configuration temporarily overrides the cell DRX configuration.

In some embodiment, the first control message or a second control message that follows the first control message schedules a UL transmission by allocating a UL resource for the UL transmission, and if the allocated UL resource for UL transmission overlaps with the cell DRX OFF duration, at least a part of the next cell DRX OFF duration is determined as cell DRX ON, wherein, the part of the next cell DRX OFF duration determined as cell DRX ON includes the allocated UL resource for UL transmission.

In some embodiment, if the first control message is transmitted in cell DRX ON duration, a first cell DRX OFF duration following the cell DRX ON duration is the next cell DRX OFF duration, and the part of the next cell DRX OFF duration determined as cell DRX ON starts from the start of the first cell DRX OFF duration or the start of receiving the UL transmission, and ends at the end of receiving the UL transmission or at the end of the first cell DRX OFF duration; and if the first control message is transmitted in a second cell DRX OFF duration, the second cell DRX OFF duration is the next cell DRX OFF duration, and the part of the next cell DRX OFF duration determined as cell DRX ON starts upon transmitting the first control message or from the start of receiving the UL transmission, and ends at the end of receiving the UL transmission or at the end of the second cell DRX OFF duration.

In some embodiment, the dynamic configuration overrides one or more next cell DRX ON durations or one or more next cell DRX OFF durations.

In some embodiment, the processor is further configured to configure a larger value to a timer that controls the activated state or deactivated state of the serving cell or of the BWP of the serving cell.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
support network energy saving (NES); and
receive a cell discontinuous reception (DRX) configuration, wherein the cell DRX configuration comprises information associated with at least one duration for a first cell to not receive at least partial uplink (UL) transmission from the UE.

2. The UE of claim 1, wherein the cell DRX configuration includes a cell DRX ON duration and a cell DRX OFF duration, and the at least one processor is further configured to cause the UE to determine an UL resource for UL transmission if an allocated UL resource for UL transmission overlaps with the cell DRX OFF duration.

3. The UE of claim 2, wherein the determined UL resource for UL transmission is an available UL resource included in the allocated UL resource for UL transmission, and wherein the available UL resource does not overlap with the cell DRX OFF duration.

4. The UE of claim 3, wherein the at least one processor is further configured to cause the UE to assemble or reassemble medium access control (MAC) protocol data units (PDUs) according to the available UL resource.

5. The UE of claim 3, wherein the determined UL resource for UL transmission is the a next allocated UL resource for UL transmission that does not overlap with the cell DRX OFF duration, and the at least one processor is configured to cause the UE to receive a configuration of enabling autonomous transmission or autonomous retransmission for UL transmission and transmit the UL transmission by autonomous transmission or autonomous retransmission.

6. The UE of claim 2, wherein the at least one processor is configured to cause the UE to transmit the UL transmission on the allocated UL resource for UL transmission that overlaps with the cell DRX OFF duration.

7. The UE of claim 6, wherein the at least one processor is configured to cause the UE to:
receive a configuration of enabling autonomous retransmission of the UL transmission, and a timer associated with the autonomous retransmission;
start the timer upon transmitting the UL transmission; and
upon the timer being expired, retransmit, the UL transmission on the next allocated UL resource for UL transmission that does not overlap with the cell DRX OFF duration.

8. The UE of claim 2, wherein the at least one processor is configured to cause the UE to receive a configuration on forbidding piggyback on a physical uplink control channel (PUCCH) transmitted in UL resource that overlaps with the cell DRX OFF duration.

9. The UE of claim 2, wherein, if the allocated UL resource for UL transmission that overlaps with the cell DRX OFF duration is by allocated by dynamic scheduling, the dynamic scheduling is ignored.

10. A method performed by a user equipment (UE), wherein the UE supports network energy saving (NES), and the method comprises:
receiving a cell discontinuous reception (DRX) configuration, wherein the cell DRX configuration comprises information associated with at least one duration for a first cell to not receive at least partial uplink (UL) transmission from the UE.

11. A base station, comprising:
at least one memory; and
at least one processor coupled with the at least one memory and configured to cause the base station to:
support network energy saving (NES); and
transmit a cell discontinuous reception (DRX) configuration, wherein the cell DRX configuration comprises information associated with at least one duration for a first cell to not receive at least partial uplink (UL) transmission from UE.

12. The base station of claim 11, wherein the cell DRX configuration includes a cell DRX ON duration and a cell DRX OFF duration, and the at least one processor is configured to cause the base station to transmit a first control message that indicates or implies a dynamic configuration, and the dynamic configuration temporarily overrides the cell DRX configuration.

13. The base station of claim 12, wherein:
the first control message or a second control message that follows the first control message schedules a UL transmission by allocating a UL resource for the UL transmission; and
if the allocated UL resource for UL transmission overlaps with the cell DRX OFF duration, at least a part of the next cell DRX OFF duration is determined as cell DRX ON, wherein the part of the next cell DRX OFF duration determined as cell DRX ON includes the allocated UL resource for UL transmission.

14. The base station of claim 12, wherein: if the first control message is transmitted in cell DRX ON duration, a first cell DRX OFF duration following the cell DRX ON duration is the next cell DRX OFF duration, and the part of the next cell DRX OFF duration determined as cell DRX ON starts from the start of the first cell DRX OFF duration or the start of receiving the UL transmission, and ends at the end of receiving the UL transmission or at the end of the first cell DRX OFF duration; and
if the first control message is transmitted in a second cell DRX OFF duration, the second cell DRX OFF duration is the next cell DRX OFF duration, and the part of the next cell DRX OFF duration determined as cell DRX ON starts upon transmitting the first control message or from the start of receiving the UL transmission, and ends at the end of receiving the UL transmission or at the end of the second cell DRX OFF duration.

15. The base station network device of claim 13, wherein the dynamic configuration overrides one or more next cell DRX ON durations or one or more next cell DRX OFF durations.

16. A processor for wireless communication, comprising:
at least one controller coupled with at least one memory and configured to cause the processor to:
support network energy saving (NES); and
receive a cell discontinuous reception (DRX) configuration, wherein the cell DRX configuration comprises information associated with at least one duration for a first cell to not receive at least partial uplink (UL) transmission from the processor.

17. The processor of claim 16, wherein the cell DRX configuration includes a cell DRX ON duration and a cell DRX OFF duration, and the at least one controller is configured to cause the processor to determine an UL resource for UL transmission if an allocated UL resource for UL transmission overlaps with the cell DRX OFF duration.

18. The processor of claim 17, wherein the determined UL resource for UL transmission is an available UL resource included in the allocated UL resource for UL transmission, and wherein the available UL resource does not overlap with the cell DRX OFF duration.

19. The processor of claim 18, wherein the at least one controller is configured to cause the processor to assemble or reassemble medium access control (MAC) protocol data units (PDUs) according to the available UL resource.

20. The processor of claim 18, wherein the determined UL resource for UL transmission is a next allocated UL resource for UL transmission that does not overlap with the cell DRX OFF duration, and the at least one controller is configured to cause the processor to receive a configuration of enabling autonomous transmission or autonomous retransmission for UL transmission and transmit the UL transmission by autonomous transmission or autonomous retransmission.
